(19) United States
(12) Patent Application Publication
(10) Pub. No.: US 2015/0166346 A1
(43) Pub. Date: Jun. 18, 2015

(54) METHOD OF FABRICATING GRAPHITE FILMS

(71) Applicant: Chung-Shan Institute of Science and Technology, Armaments Bureau, M.N.D, Taoyuan County (TW)

(72) Inventors: Hsin-Ping Chang, Taoyuan County (TW); Cheng-Jung Ko, Taoyuan County (TW); Chin-Wei Kuo, Taoyuan County (TW); Chuen-Ming Gee, Taoyuan County (TW); Pai-Lu Wang, Taoyuan County (TW); Ching-Jang Lin, Taoyuan County (TW); Dam-Ming Chiou, Taoyuan County (TW)

(73) Assignee: Chung-Shan Institute of Science and Technology, Armaments Bureau, M.N.D, Taoyuan County (TW)

(21) Appl. No.: 14/133,532

(22) Filed: Dec. 18, 2013

(51) Int. Cl. C01B 31/04

(52) U.S. Cl. CPC C01B 31/04

(57) ABSTRACT

In a method of fabricating graphite films, mesophase pitch, a polymer material and an organic solvent are used to produce a carbon precursor slurry, and the carbon precursor slurry is coated to produce the graphite films. Since the method of using natural graphite as a raw material in production requires a number of purification processes to manufacture an expanded graphite powder before the graphite films can be produced, and thus the fabricating cost is very high, and other high-priced materials such as polyimide (PI) or graphene also will increase the total cost.

### BACKGROUND OF THE INVENTION

1. Field of Invention

The present invention relates to a method of fabricating high-quality graphite films with high orientation from low-cost materials quickly.

2. Description of Related Art

As disclosed in GrafTech patents (WO2002066245, WO2003001133 and WO2004059696), natural graphite is used as a raw material in production, wherein the natural graphite is purified to produce expanded graphite, and then the expanded graphite is kneaded and sintered to produce graphite films, and thus this fabricating method incurs a higher fabricating cost.

As disclosed in Matsushita and Kaneka patents (U.S. Pat. No. 7,252,795, EP0449312, U.S. Pat. No. 8,512,670, US20130164210, WO2006057183), polyimide (PI) is used as a raw material in production, wherein PI is carbonized, graphitized, and sintered at a high temperature to produce graphite films. Since the material cost of PI is very high, the total cost and selling price are also very high.

As disclosed in SKC patent (WO2013078180), polyethylene terephthalate (PET) is used as a raw material in production, wherein PET is carbonized and graphitized to produce graphite films. Although the cost of PET is much lower than that of PI, yet the graphite films obtained after the sintering takes place has a thermal conductivity much smaller than that of PI.

As disclosed in other patents (WO212134205 and EP2541559), graphene produced by a chemical vapor deposition (CVD) process has a very high thermal conductivity, but the CVD process and related equipments incur a high cost, and the graphene so produced is too thin and relatively inconvenient to use.

As described above, the prior arts have the following drawbacks: The method of using natural graphite as a raw material requires a purification process to produce the expanded graphite powder, and thus incurring a higher fabricating cost. The method of using the expensive PI as a raw material incurs a higher material cost. The method of costing graphene on a surface incurs a higher fabricating cost.

### SUMMARY OF THE INVENTION

In view of the aforementioned drawbacks of the prior art, it is a primary objective of the present invention providing a method of fabricating high-quality graphite films with high orientation from low-cost materials quickly to avoid using the expensive PI material and overcome the drawbacks of the prior art.

To achieve the foregoing objectives, the present invention provides a method of fabricating graphite films to avoid using the expensive PI as the raw material in production, so as to lower the production cost of graphite, and this method uses mesophase pitch as a raw material together with an organic solvent, and a polymer material to produce a carbon precursor material with a low fabricating cost. In addition, a scraping process is used for coating to reduce the cost and time of fabricating the graphite films, and the etched metal and used chemical agents can be recycled and reused.

The technical characteristics, objectives and advantages of the present invention can be further understood by the following detailed description of preferred embodiments and related drawings.

### BRIEF DESCRIPTION OF THE DRAWING

FIG. 1 is a flow chart of a method of fabricating graphite films in accordance with the present invention.

### DETAILED DESCRIPTION OF THE INVENTION

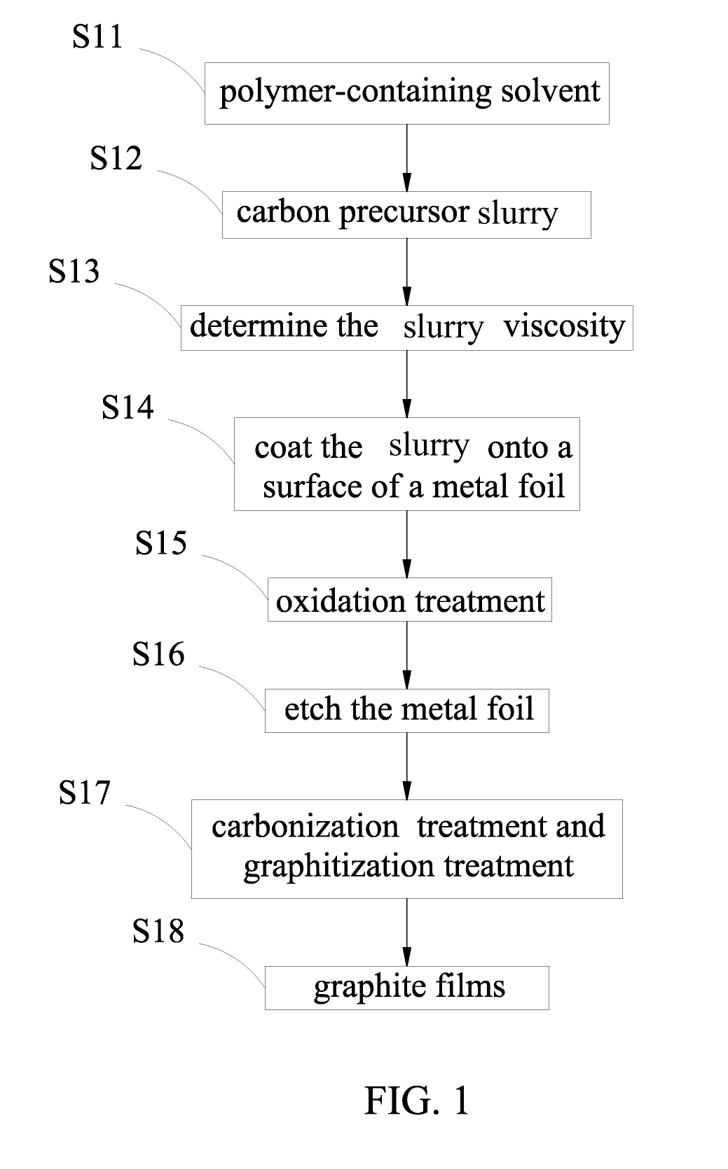

With reference to FIG. 1 for a flow chart of a method of fabricating graphite films with low cost, quick formation and high quality in accordance with the present invention, the method (10) includes a total of eight steps including Steps (11) to (18).

Step (11): Mix an organic solvent such as ethanol, acetone, toluene, methylpyrrolidone, quinoline, pyridine, or any mixture of the above with a polymer material uniformly to produce a polymer-containing solvent by a conventional mix apparatus, wherein the polymer material can be polymethyl methacrylate, epoxy resin, phenolic resin, polycarbonate, polyimide, polyethylene terephthalate or any mixture of the above, and the rotation time in Step (11) is controlled within a range of 0.1˜24 hrs, and preferably within a range of 0.5˜8 hrs, and the rotation speed of the mix apparatus is controlled within a range of 5˜100 rpm, and preferably within a range of 10˜50 rpm.

Step (12): Mix the polymer-containing solvent with the mesophase pitch uniformly to produce a carbon precursor slurry in Step (12), wherein the mesophase pitch includes an anisotropic area of 50 wt % or more, and the rotation time in Step (12) is controlled within a range of 0.1˜24 hrs, and preferably within a range of 0.5˜8 hrs, and the rotation speed of said mix apparatus is controlled within a range of 5˜100 rpm and preferably within a range of 10˜50 rpm.

Step (13): Measure the slurry viscosity of the carbon precursor slurry obtained in the Step (12) and determine whether the range of the slurry viscosity falls within a range of 50˜1,000 cps. If yes, then go to the Step (14), or else return to the Step (12). Preferably, the slurry viscosity falls within a range of 100˜500 cps. If the slurry viscosity is greater than 1,000 cps, the fluidity of the slurry is worse, indicating that the ratio of the mesophase pitch to the polymer material is too high, so that thin films cannot be formed easily in the later fabricating processes. If the slurry viscosity is smaller than 50 cps, the fluidity of the slurry is good, because fluid with low viscosity flow much more easier than that with high viscosity, and indicating that the percentage of the organic solvent is excessive, so that the thin films cannot be fabricated by scraping. In addition, the films may be broken or cracked easily. If the slurry viscosity falls within a range of 50˜1,000 cps, the fabricating process enters into the Step (14), and the carbon precursor slurry is coated onto a surface of a metal foil by tape casting, wherein the scraper speed is controlled within a range of 1˜10 mm/sec, and preferably within a range of 0.2˜5 mm/sec, and the metal foil can be copper foil, nickel foil, stainless steel foil, or titanium foil with a thickness smaller than 100 microns. Wherein, the thin films formed after tape casting has a thickness smaller than 400 microns, and the films are placed in an oven.

Step (15): Conduct an oxidation treatment by oxygen or air, wherein the oxidation temperature is controlled within a range of 200˜300° C. and preferably within a range of 220˜280° C., and the oxidation time is controlled within a range of 0.1˜5 hrs, and preferably within a range of 0.5˜3 hrs.

Step (16): Etch the metal foil with etchant which can be ammonium sulfate, iron chloride, sulfuric acid, nitric acid, hydrochloric acid, or any mixture of the above.

Step (17): Conduct a carbonization treatment, wherein the carbonization temperature is controlled within a range of 600˜1500° C., and preferably within a range of 1000˜1400° C. The carbonization is the term for conversion of an organic substance (the polymer and mesophase pitch) into carbon containing residue through pyrolysis. In the graphitization of the Step (17), the graphitization temperature is controlled within a range of 2000˜3300° C. and preferably within a range of 2300˜3000° C. In the graphitization, the carbon is converted into a graphite structure.

Step (18): Obtain the graphite films from Step (17), with high optical-anisotropic and high orientation graphite structure.

While the invention has been described by means of specific embodiments, numerous modifications and variations could be made thereto by those skilled in the art without departing from the scope and spirit of the invention set forth in the claims.

What is claimed is:

1. A method of fabricating graphite films, characterized in that a mesophase pitch, an organic solvent, and a polymer material are used to fabricate a carbon precursor material for fabricating the graphite films, and the method comprises the steps of:
Step (11): fabricating a polymer-containing solvent from the organic solvent and the polymer material;
Step (12): fabricating a carbon precursor slurry from the polymer-containing solvent and the mesophase pitch;
Step (13): determining whether the viscosity of the carbon precursor slurry falls within a predetermined range, and entering into the Step (14) if the viscosity falls within the predetermined range, or returning to the Step (12), if the viscosity does not fall within the determined range;
Step (14): coating the carbon precursor slurry onto a surface of a metal foil;
Step (15): conducting oxidation treatment;
Step (16): removing the metal foil by an etching treatment; and
Step (17): conducting carbonization treatment and graphitization treatment.

2. The method of fabricating graphite films of claim 1, wherein the organic solvent of the Step (11) is one selected from the group consisting of ethanol, acetone, toluene, methylpyrrolidone, quinoline, pyridine, and a mixture thereof.

3. The method of fabricating graphite films of claim 1, wherein the polymer material of the Step (11) is one selected from the group consisting of polymethyl methacrylate, epoxy resin, phenolic resin, polycarbonate, polyimide, polyethylene terephthalate and a mixture thereof.

4. The method of fabricating graphite films of claim 1, wherein the mesophase pitch of the Step (12) has a content greater than an anisotropic area of 50 wt % or more.

5. The method of fabricating graphite films of claim 1, wherein the Steps (11) and (12) further respectively includes a rotation and a rotation speed.

6. The method of fabricating graphite films of claim 5, wherein the rotation time is controlled within a range of 0.1˜24 hrs.

7. The method of fabricating graphite films of claim 1, wherein the rotation speed is controlled within a range of 5˜100 rpm.

8. The method of fabricating graphite films of claim 1, wherein the slurry viscosity of the Step (13) falls within a range of 50˜1,000 cps.

9. The method of fabricating graphite films of claim 1, wherein the Step (14) is carried out by scraping.

10. The method of fabricating graphite films of claim 9, wherein a scraping speed is controlled within a range of 1˜10 mm/sec.

11. The method of fabricating graphite films of claim 1, wherein the metal foil of the Step (14) is one selected from the group consisting of copper foil, nickel foil, stainless steel foil, titanium foil, and aluminum foil.

12. The method of fabricating graphite films of claim 1, wherein the metal foil of the Step (14) has a thickness smaller than 100 microns.

13. The method of fabricating graphite films of claim 1, wherein the thin film formed on a surface of the metal foil has a thickness smaller than 400 microns.

14. The method of fabricating graphite films of claim 1, wherein the oxidation treatment of the Step (15) further includes a oxidation temperature control and a oxidation time control.

15. The method of fabricating graphite films of claim 14, wherein the oxidation temperature is controlled within a range of 200˜300° C.

16. The method of fabricating graphite films of claim 14, wherein the oxidation time is controlled within a range of 0.1˜5 hrs.

17. The method of fabricating graphite films of claim 1, wherein an etchant for the etching treatment in the Step (16) is one selected from the group consisting of ammonium sulfate, iron chloride, sulfuric acid, nitric acid, hydrochloric acid, and a mixture thereof.

18. The method of fabricating graphite films of claim 1, wherein a carbonization temperature of the Step (17) is controlled within a range of 600˜1500° C.

19. The method of fabricating graphite films of claim 1, wherein a graphitization temperature of the Step (17) is controlled within a range of 2000˜3300° C., and preferably within a range of 2500˜3000° C.
